(19) United States
(12) Patent Application Publication
(10) Pub. No.: US 2006/0050008 A1
(43) Pub. Date: Mar. 9, 2006

(54) Cutoff transmission and or reception antenna

(76) Inventors: Sebastien Morand, Vallauris (FR); Philippe Berthault, Valbonne (FR)

Correspondence Address: JAMES C. LYDON, 100 DAINGERFIELD ROAD, SUITE 100, ALEXANDRIA, VA, 22314, US

(21) Appl. No.: 10/149,251

(22) PCT Filed: Oct. 11, 2001
(86) PCT No.: PCT/FR01/03135

§ 371 Date: Sep. 25, 2003

(30) Foreign Application Priority Data
Oct. 11, 2000 (FR) 00/12981

(51) Int. Cl. H01Q 1/36

(52) U.S. Cl. 343/895

(57) ABSTRACT

An electromagnetic wave transmission and/or reception antenna (10) which includes a flat spiral wire, the spiral having at least two turns; the antenna including at least one cut (12) for the purpose of reducing the inter-turn capacitance. Such an antenna is used in a contactless communication system in which the reader transmits electromagnetic signals to a portable object (card or ticket) in order to identify the holder of the portable object when the latter transmits return identification signals to the reader.

The present invention broadly concerns spiral type electromagnetic transmission and/or reception antennas and particularly a spiral transmission and/or reception antenna with cuts.

In applications where it is necessary to use transmission/reception antennas which exchange electromagnetic waves with a portable object possessed by a user, it is increasingly necessary to provide relatively large antennas to be able to adapt to the portable object's operating volume. Contactless communication technology is such that the user's portable object is a card or a ticket featuring an antenna designed to receive electromagnetic signals sent from a reader and to transmit other electromagnetic signals to the reader in order to gain access to a controlled access zone. The electromagnetic signals allow communication not only between the reader and the portable object but also remote power feeding of the portable object through the physical phenomenon of magnetic induction.

There is a trend to increase the portable object's operating volume in order to facilitate the passage of users who no longer have to target a specific zone and also in order to detect the portable object held by the user more easily (in a pocket, for example) for the general purpose of detecting fraudulent activity and/or monitor entries/exits (as in the case of a hands-free passageway). This increase in operating volume results in an increase in the dimensions of the transmitter antenna and an increase in the operating distance between the transmitting antenna and the portable object. The increase in operating distance may be ensured by increasing the power supplied to the antenna but this would involve an increase in electrical consumption as well as the number of turns. The radiated magnetic field is proportional to the number of turns when the same current runs through them.

However, the increase in the number of turns thus involves a parallel inter-turn capacitance due to the capacitive coupling between two parallel turns of the antenna. At a given operating frequency, the higher the capacitance, the weaker the impedance. As a result, a significant portion of the current is dissipated by this capacitance instead of entering the antenna. Furthermore, interference due to capacitive coupling between the turns occurs, by virtue of the phase change when the length of the antenna exceeds one fourth of the wave length and particularly when it nears the half-wave length, which occurs when the antenna reaches approximately 11 m at the currently used operating frequency of 13.56 MHz.

This is why the purpose of the invention is to produce a spiral type transmission and/or reception antenna in which there is no current dissipation due to inter-turn capacitance regardless of the dimensions of the antenna turns.

The object of the invention is thus an electromagnetic wave transmission and/or reception antenna of the type featuring a flat spiral wire, said spiral having at least two turns, this antenna being characterized in that it includes at least one cut in the antenna wire for the purpose of reducing the inter-turn capacitance.

The purposes, objects and characteristics of the invention will become more apparent from the following description when taken in conjunction with the accompanying drawings in which:

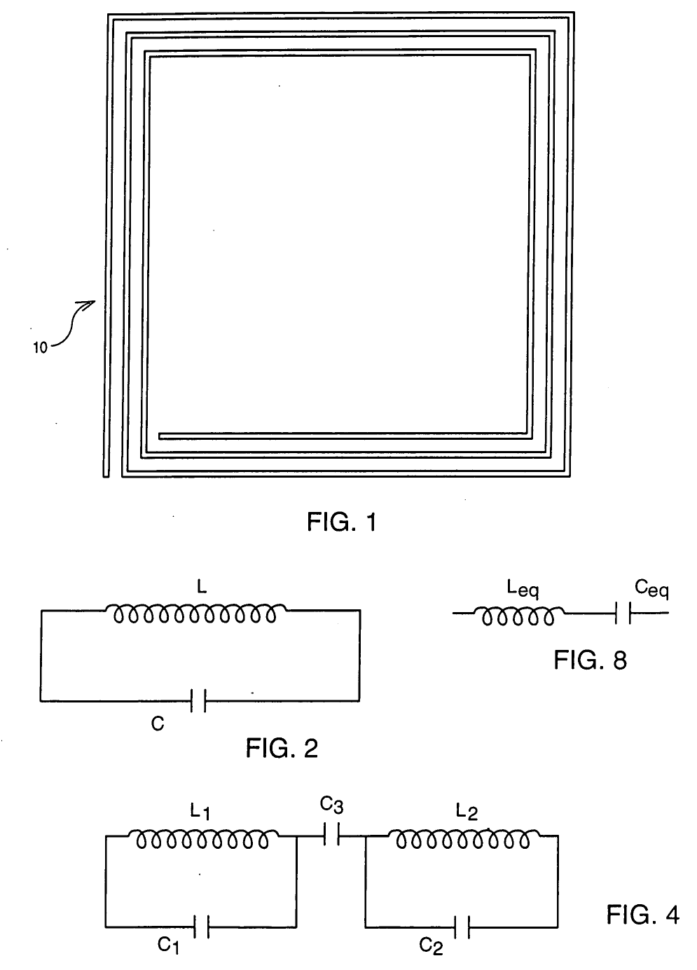

FIG. 1 represents a three-turn spiral antenna allowing implementation of the invention,

FIG. 2 represents the electronic circuit equivalent to the antenna illustrated in FIG. 1.

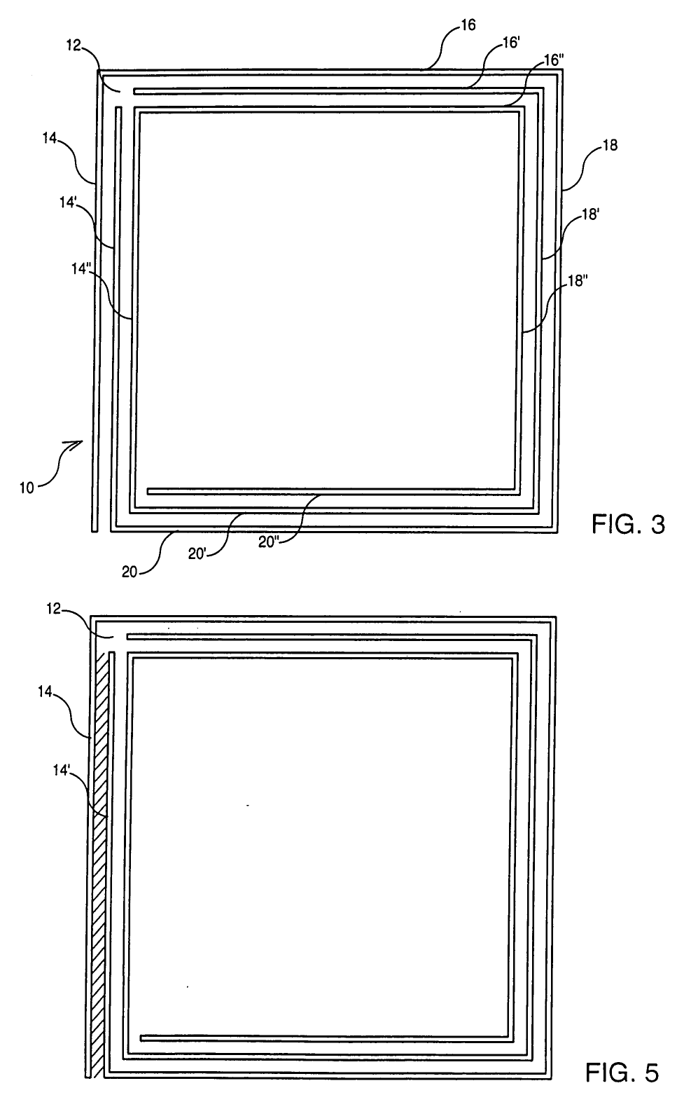

FIG. 3 represents the antenna shown in FIG. 1 in which the cut has been made,

FIG. 4 represents the electronic circuit equivalent to the antenna illustrated in FIG. 3,

FIG. 5 schematically represents the wires of the antenna with the cut occurring in the parallel capacitance of the antenna portion located on one side of the cut,

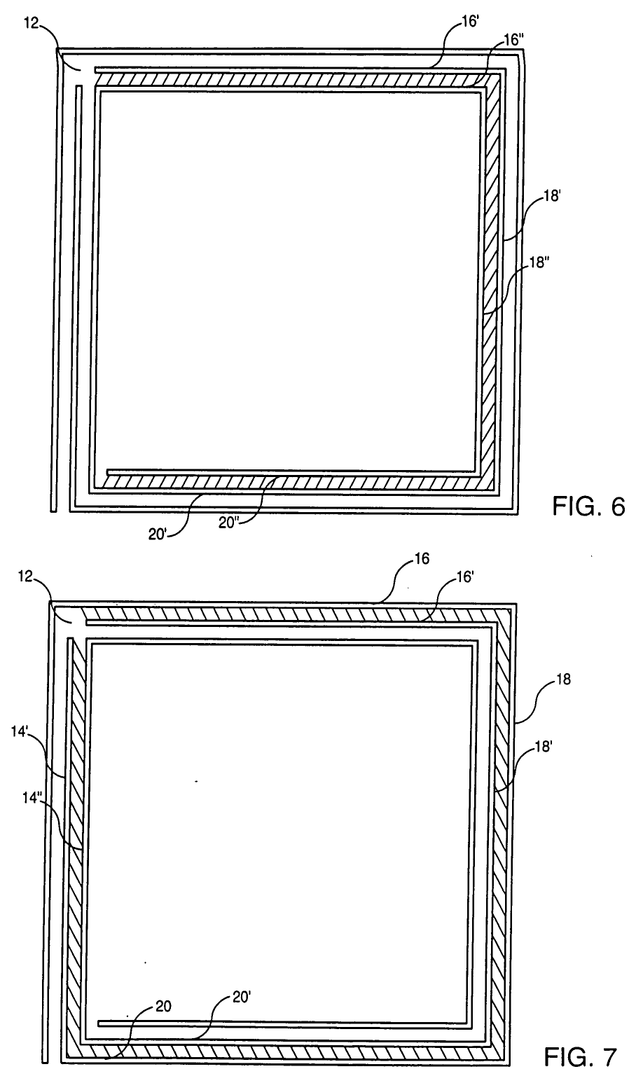

FIG. 6 schematically represents the antenna wires with the cut occurring in the parallel capacitance of the antenna portion located on the other side of the cut,

FIG. 7 schematically represents the antenna wires with the cut occurring in the series capacitance located between the two parts of the antenna, and

FIG. 8 represents the series circuit equivalent to the antenna illustrated in FIG. 3.

The antenna 10, shown in FIG. 1, can be used as a transmitter antenna in a contactless communication system where each user possesses a card (or a ticket) also equipped with an antenna. Electromagnetic signals transmitted by the antenna of a reader such as the antenna 10 are captured by the antenna in the user's card which then retransmits other electromagnetic signals to antenna 10 granting the user access to a controlled access zone.

As explained above, the antenna 10 may be relatively large and feature a significant number of turns if a large operating volume is desired. The antenna 10 may be represented by the electronic circuit in FIG. 2, the parallel capacitance C between turns becomes very high in relation to the antenna's inductance L. If ω is the pulse used (ω=2πf), the impedance due to the capacitance becomes much less large than the antenna inductance according to the formula

$$\frac{1}{C \cdot ω} < L \cdot ω$$

At the very worst, the antenna itself is short-circuited by the inter-turn capacitance and hardly any current passes in the antenna. As the magnetic field emitted is proportional to the current running in the antenna, it is low and the result opposite that desired is achieved.

In order to offset this inconvenience, the parent idea behind the invention is to make one or more cuts in the antenna wire. A cut such as cut 12 made in the antenna illustrated in FIG. 3, is in fact a definite interruption in the antenna wire of several millimeters and may reach several centimeters.

The electronic circuit equivalent to the antenna having a cut thus becomes the circuit represented in FIG. 4 where the part located in front of the cut is equivalent to the inductance L1 in parallel with the inter-turn capacitance C1, and the part located after the cut is equivalent to an inductance L2 in parallel with the inter-turn capacitance C2, the two parts being linked by a series capacitance C3.

The capacitance values C1, C2 and C3 are due to capacitive coupling between certain antenna wires as illustrated in FIGS. 5, 6 and 7. In this manner, the parallel capacitance C1, is due to the capacitive coupling between antenna wires 14 and 14′ and the parallel -capacitance C2 is due to the capacitive coupling between wires 16′ and 16″, wires 18′ and 18″ and wires 20′ and 20″. As far as the series capacitance C3 is concerned, it is due to the capacitive coupling between wires 16 and 16′, wires 18 and 18′, wires 20 and 20′ and wires 14′ and 14″.

Each cut made in the antenna thus enables Li-Ci pairs of lesser value on each side of the cut than the L-C pair of the antenna with no cuts. It can thus initially be thought that as the number of cuts increases, the L-C pairs have low values which promote current in the inductance elements. It is, in fact, judicious to provide a number of cuts corresponding to the antenna's series resonance, which corresponds to the maximum current in the antenna and in the turns. The invention will become more apparent with the following example for the determination of the number of turns.

Firstly, one must understand that the purpose of the cuts made in the antenna is to significantly lower the values of L and C for each L-C pair, located on either side of a cut. In this case, the impedance due to the capacitance is distinctly greater than the inductance, i.e. in the case of a single cut:

$$L1 ω < \frac{1}{C1 ω}$$

If ω1 is the pulse corresponding to the resonance of the cell L1, C1 thus:

$$ω {1}^{2} = \frac{1}{L1C1} and ω 1 > ω$$

Consequently, this cell is equivalent to an inductance of value L1eq

$$L1eq = \frac{Z1t}{j \cdot ω}$$

$$where \text{:} \frac{1}{Z1t} = ( \frac{1}{j \cdot L1 \cdot ω} ) + jC \cdot ω that is \frac{1}{Z1t} = \frac{( 1 - L1 \cdot C1 \cdot {ω}^{2} )}{j \cdot L1 ω}$$

$$thus \text{:} L1eq = \frac{L1}{( 1 - L1 \cdot C1 \cdot {ω}^{2} )} or L1eq = \frac{L1}{[ 1 - {( \frac{ω}{ω 1} )}^{2} ]}$$

thus resulting in
L1eq>0 as ω1>ω

In the same manner, for cell L2, C2, we have

$$L2 ω < \frac{1}{C2 ω}$$

If ω2 is the pulse corresponding to the resonance of the cell L2, C2, we thus have:

$$ω {2}^{2} = \frac{1}{L2C2} and ω 2 > ω$$

Cell L2, C2 is equivalent to an inductance of value L2eq:

$$L2eq = \frac{L2}{( 1 - L2 \cdot C2 \cdot )} or L2eq = \frac{L2}{[ 1 - {( \frac{ω}{ω 2} )}^{2} ]}$$

thus resulting in: L2eq>0 as ω2>ω

Consequently, when the resonance frequency specific to each cell is definitely greater than the frequency of the current which passes through the antenna, the current is much greater in the turns than that which flows through the inter-turn capacitors. The more this resonance frequency specific to each cell increases, the more the current increases in the turns. This occurs when the number of cuts is increased.

However, if the number of cuts is excessive, tuning between the antenna's equivalent inductance and the antenna's equivalent cut capacitance may be impossible.

With N representing cuts equally distributed on the antenna, it can be inferred that the antenna was divided into N+1 identical cells, such that:
Leq2=Leq2= . . . =Leq(N+1)

If Cci is the cut capacitance (or series capacitance) of cut i, there are thus N identical cut capacitance values:
Cc1=Cc2= . . . =CcN=Cc

If C is the inter-turn capacitance of each cell and Cant is the antenna's total inter-turn capacitance and by accepting an initial approximation that the cut capacitance between two cells is equal to the inter-turn capacity of each cell, or Cc=C, we thus have:

$$Cc = \frac{Cant}{2 N + 1}$$

It can thus be admitted that the electronic circuit equivalent to the antenna with N equally distributed cuts is that represented in FIG. 8, with:

$$Leq = ( N + 1 ) \cdot Leq1$$

$$Ceq = \frac{Cc}{N} = \frac{Cant}{N ( 2 N + 1 )}$$

If ω2 is the pulse corresponding to the series resonance of the antenna represented in FIG. 8, and if Lant is the total inductance of the antenna, then:

$$Leq \cdot Ceq \cdot {ω}^{2} = 1 \\ [ ( N + 1 ) \cdot Leq1 \cdot \frac{Cant}{( 2 \cdot N + 1 ) \cdot N} ] \cdot ω {r}^{2} = 1 with \\ Leq = ( N + 1 ) \cdot Leq1 and Ceq = \frac{Cant}{( 2 \cdot N + 1 ) \cdot N} \\ Leq1 \cdot Cant \cdot ω {r}^{2} = \frac{[ ( 2 \cdot N + 1 ) \cdot N ]}{( N + 1 )} \qquad ( 1 )$$

It has been seen that Leq1 may be written as:

$$\begin{matrix}Leq1 = \frac{L1}{( 1 - L1 \cdot C1 \cdot ω {r}^{2} )} \\ Leq1 = \frac{[ \frac{Lant}{( N + 1 )} ]}{[ 1 - [ \frac{Lant}{( N + 1 )} ] \cdot ( \frac{Cant}{2 \cdot N + 1} ) \cdot ω {r}^{2} ]} with \\ L1 = [ \frac{Lant}{( N + 1 )} ] and C1 = ( \frac{Cant}{2 \cdot N + 1} ) \\ Leq1 = \frac{[ Lant \cdot ( 2 \cdot N + 1 ) ]}{( N + 1 ) \cdot ( 2 \cdot N + 1 ) - Lant \cdot Cant \cdot ω {r}^{2}}\end{matrix}$$

by using the relationship (1), N verifies:

$$[ \frac{[ Lant \cdot ( 2 \cdot N + 1 ) ]}{( N + 1 ) \cdot ( 2 \cdot N + 1 ) - Lant \cdot Cant \cdot ω {r}^{2}} ] = [ \frac{[ ( 2 \cdot N + 1 ) \cdot N ]}{( N + 1 ) \cdot Cant \cdot ω {r}^{2}} ]$$

$$such that \text{:} N \cdot ( N + 1 ) \cdot ( 2 \cdot N + 1 ) - 2 \cdot N \cdot Lant \cdot Cant \cdot ω {r}^{2} - Lant \cdot Cant \cdot ω {r}^{2} = 0$$

$$such that \text{:} {N}^{2} + N - ( Lant \cdot Cant \cdot ω {r}^{2} ) = 0$$

$$Thus \text{:} N = \frac{( - 1 + \sqrt{Δ} )}{2} with Δ = ( 1 + 4 \cdot Lant \cdot Cant \cdot ω {r}^{2} )$$

$$Such that \text{:} N = \frac{[ - 1 + \sqrt{( 1 + 4 \cdot Lant \cdot Cant \cdot ω {r}^{2} )} ]}{2}$$

In this manner, if a transmitter antenna operating at 13.56 MHz is considered, the number of cuts to be made to obtain the series resonance of the antenna can be calculated: N=3.444.

We can thus take N=3 or N=4 cuts.

With N=3, the proportion of current passing through the turns and the proportion of current dissipated by the inter-turn capacitance can be calculated:
an inter-turn capacitance value of

$$C1 = \frac{C}{2 \cdot N + 1} C1 = 1.1017 \times {10}^{- 11}$$
an inductance value at pulse wr

$$L1 = \frac{L}{( N + 1 )} L1 = 8.64 \times {10}^{- 6}$$
the current in the turns is:

$$IL = \frac{( \frac{1}{C1 \cdot ω r} )}{[ ( \frac{1}{C1 \cdot ω r} ) + L1 \cdot ω r ]}$$

$$IL = 0.611 ( or 61 \% of the total current in the antenna )$$
the current passing in the inter-turn capacitance is

$$IC = \frac{( L1 \cdot ω )}{[ ( \frac{1}{C1 \cdot ω r} ) + L1 \cdot ω r ]}$$

$$IC = 0.389 ( or 39 \% of the total current of the antenna )$$

1-7. (canceled)

8. An electromagnetic transmission and/or reception antenna comprising a wire formed in a flat spiral having at least two turns, wherein said antenna includes at least one cut capable of reducing an inter-turn capacitance.

9. The antenna of claim 8, wherein said wire has a length at least equal to one fourth of the wavelength of an electromagnetic wave.

10. The antenna of claim 9, further comprising at least one additional cut, and wherein the cuts are distributed in such a way as to form equal portions of said wire on each side of the cut.

11. The antenna of claim 10, comprising three equally distributed cuts.

12. A contactless communication system, comprising a plurality of contactless cards each having an antenna, a card reader having the antenna of claim 8, such that the reader transmits electromagnetic signals to a contactless card in such a way as to be able to identify the holder of said contactless card when the latter transmits return identification signals to said reader.

13. The communication system of claim 12, wherein said contactless communication system is a system for gaining access to a controlled access zone.

14. The communication system of claim 13, wherein said electromagnetic signals have a frequency of 13.56 Hz.
